(19) United States
(12) Patent Application Publication
(10) Pub. No.: US 2004/0178979 A1
(43) Pub. Date: Sep. 16, 2004

(54) Display device, liquid crystal display device and driving method of the same

(75) Inventors: Yoshiteru Watanabe, Kawasaki-city (JP); Takaaki Sakurai, Sagamihara-Shi (JP); Yasuhito Kikuchi, Yamato-city (JP)

Correspondence Address: INTERNATIONAL BUSINESS MACHINES CORPORATION, DEPT. 18G, BLDG. 300-482, 2070 ROUTE 52, HOPEWELL JUNCTION, NY, 12533, US

(73) Assignee: International Business Machines Corporation, Armonk, NY

(21) Appl. No.: 10/061,886

(22) Filed: Jan. 31, 2002

(30) Foreign Application Priority Data
Feb. 6, 2001 (JP) 2001-030240

(51) Int. Cl. G09G 3/36

(52) U.S. Cl. 345/96

(57) ABSTRACT

A display device capable of reducing screen flickering or flickers is dislcosed. More particularly, a technology for preventing an occurrence of flickers in the liquid-crystal display device of an active matrix type is disclosed. In a first frame, a drive voltage of a polarity determined in units of row based on a random number is applied. In a sequential second frame, a drive voltage of a polarity reverse to the polarity in the first frame is applied. The patterns of the polarities are alternately repeated.

### BACKGROUND OF THE INVENTION

The present invention relates to a display device capable of reducing screen flickering, so-called flickers, and more particularly to a technology for preventing an occurrence of flickers in the liquid crystal display device of an active matrix type.

As a liquid crystal display device, a liquid crystal display device of an active matrix type using a thin film transistor (TFT) has been known. The liquid crystal display device of the active matrix type is constructed in such a manner that liquid crystal material serving as an optical element is sealed between a TFT array substrate having gate lines and signal lines arranged in a matrix form with thin film transistors disposed on each of intersections thereon and an opposite substrate arranged at specified distance from the foregoing TFT array substrate. Each of the thin film transistor controls a voltage given to the liquid crystal material, thus allowing a display by utilizing an electrooptical effect of the liquid crystal material.

The liquid crystal material is driven by an AC voltage applied thereto, because a life of the material becomes shortened if driven by a DC voltage. In such case, a polarity of a voltage applied to the liquid crystal material is reversed based on a common voltage in every frame, i.e., a period from the start of one display of one screen to termination of the same. However, as crosstalk is generated, a system of simply and simultaneously reversing an entire screen is not practical. Thus, to prevent the generation of crosstalk, a driving method for shifting a phase of the reversal of polarity of each pixel has been employed. Representative known methods include an H-line reversal drive control system for shifting the phase for each horizontal line, a V-line reversal drive control system for shifting the phase for each vertical line, and a dot reversal drive control system (or H/V line reversal drive control system) for alternately shifting the phases for each pixel. In the liquid crystal display device of the active matrix type, the dot reversal drive control system is currently a mainstream.

The dot reversal control system will be described by referring to FIG. 8. FIG. 8 schematically shows a liquid crystal display cell. In FIG. 8, one frame having a symbol + or − written therein represents a single pixel. Then, as shown in FIG. 8, regarding writing polarities into pixels, a pixel of positive (+) polarity in an odd-number frame is indicated as negative (−) polarity in an even-number frame. Conversely, a pixel of −polarity in an odd-number frame is indicated as +polarity in an even-number frame. It can also be understood that in any frames, writing voltages are identical in polarity for pixels adjacent to each other in a diagonal direction. This pattern is repeated alternately in odd-number and even-number frames.

In the liquid crystal display device, ideally, the pixels of +polarity and −polarity should coincide with each other in brightness. In practice, however, since there is a subtle deviation in the optical property of the liquid crystal material between +polarity and −polarity, a difference occurs in brightness therebetween. Accordingly, for example, assuming that, for all the pixels, voltages of +polarity are applied to the odd-number frames, and voltages of −polarity are applied to the even-number frames, then brightness/darkness is displayed for each frame. Such a display is recognized as a flicker. However, in the case of the dot reversal drive control system, the occurrence of flickers can be reduced because of mixed presence of +polarity and −polarity in both of the odd-number and even-number frames.

However, the dot reversal drive control system does not completely eliminate the flickers. In the case of an image for displaying a particular pattern, the occurrence of flickers is inevitable. An example is shown in FIG. 9. FIG. 9 is a schematic view showing a liquid crystal display cell similarly to FIG. 8. The example of FIG. 9 is a display image called a checker pattern in units of pixel. In FIG. 9, a white pixel represents a dark pixel, in which the common voltage is written. Specifically, in an odd-number frame, pixels of +polarity and pixels having the common voltage written therein are adjacent to each other. In an even-number frame, pixels of −polarity and pixels having the common voltage written therein are adjacent to each other. As described above, in practice, because of the subtle deviation in the optical property of the liquid crystal material between +polarity and −polarity, there is a difference in brightness therebetween. Thus, even when the dot reversal drive control system is employed, brightness/darkness is repeatedly displayed for each frame in the display image of FIG. 9. In the period of one frame, a cyclic frequency of 60 Hz is used according to the responsiveness of human eyes. Therefore, in the case shown in FIG. 9, brightness/darkness at a cycle of 30 Hz becomes a flicker to be recognized by human eyes.

Various proposals have been presented to reduce flickers. Examples include Japanese Patent Laid-Open No. Hei2(1990)-61698, No. Hei3(1991)-235918, and No. Hei9(1997)-171371. However, these proposals have still been insufficient to deal with flickers because no attention is paid to a display pattern like that shown in FIG. 9.

A reversal drive control system considered to be effective for the display pattern shown in FIG. 9 is disclosed in U.S. Pat. No. 2,820,160. While the conventional dot reversal drive control system performed the reversal of polarity in one-row unit, this reversal drive control system is designed to perform the reversal of polarity in two-row unit. FIG. 10 shows an example of the reversal of the polarity performed in two-row unit. As shown in FIG. 10, in a case of 1st, 2nd and 5th pixel rows from the top, the pixel of a 1st column from the left starts with +polarity in an odd-number frame, and the pixels of −polarity and +polarity are alternately repeated thereafter. In the same case, in an even-number frame, the pixel of a 1st column from the left starts with −polarity, and the pixels of +polarity and −polarity are alternately arrayed thereafter. In a case of 3rd and 4th pixel rows from the top, the pixel of the 1st column from the left starts with −polarity in the odd-number frame, and the pixels of +polarity and −polarity are alternately repeated thereafter. In the same case, in the even-number frame, the pixel of the 1st column from the left starts with +polarity, and the pixels of −polarity and +polarity are alternately arrayed thereafter.

In the foregoing manner, in the reversal drive control system shown in FIG. 10, the reversal of polarity is performed in two-row unit. FIG. 11 schematically shows the state in which the checker pattern is displayed in units of pixel shown in FIG. 9, by using the above-described reversal drive control system. As it is apparent from FIG. 11, in the odd-number and even-number frames, +polarity and −polarity are mixed in one frame. Accordingly, the occurrence of flickers can be reduced.

However, the reversal drive control system for performing the reversal of polarity in two-row unit has also been proven to be insufficient to deal with a checker pattern different from that shown in FIG. 9. An example is shown in FIG. 12. As shown in FIG. 12, in a case of a checker pattern in units of, i.e., 1 row×2 columns, pixels of +polarity are arrayed in an odd-number frame, and pixels of −polarity are arrayed in an even-number frame. Accordingly, as in the case shown in FIG. 9, brightness/darkness at the cycle of 30 Hz becomes a flicker to be recognized by human eyes.

### SUMMARY OF THE INVENTION

The present invention was made in consideration of the foregoing problems, and it is an object of the present invention to provide a method of reducing flickers irrespective of a display pattern.

Conventionally, as described above with reference to FIGS. 9 and 10, the polarities of the drive voltages have been arrayed in regular patterns. However, such an arrangement has been insufficient as a measure to deal with display images of other patterns, while it was effective for dealing with flickers of a display image of a particular pattern. Thus, the present invention proposes a polarity array to be determined not based on a particular pattern but randomly in units of row. The random determination of a polarity array in units of row eliminates the presence of a particular image display pattern in which flickers are easily recognized. In this case, as described above, in order to prevent a burning of a liquid crystal, a polarity of a voltage applied to each pixel for each frame should preferably be reversed. Therefore, the present invention further proposes a voltage of opposite polarity to be written in each pixel in a frame immediately after the driven frame with a polarity array being randomly determined in units of row, to which driving is performed.

Therefore, the present invention provides a display device which comprises: a display cell which includes a display optical element and displays an image by controlling light transmission based on a drive voltage applied to the display optical device; and a voltage supply circuit for randomly determining a polarity of the drive voltage in a predetermined frame, and for determining a polarity of the drive voltage in a frame subsequent to the predetermined frame by reversing the randomly determined polarity.

In the display device of the present invention, preferably, the display cell is constructed to have a plurality of pixels arrayed in a dot matrix form, and the voltage supply circuit performs random polarity determination in units of row constituting the dot matrix. In this way, the presence of a particular screen pattern, in which the flickers are easily recognized, can be eliminated.

In the display device of the present invention, preferably, the voltage supply circuit supplies the drive voltage in such a way that adjacent pixels in the same row to be different from each other in polarity. In this way, since +polarity and −polarity are present in a mixed manner in the same row, thus in the same frame, unbalance of polarity in each frame can be reduced.

In the display device of the present invention, basic steps include random determination and application of polarity of the drive voltage and a reversal of the polarity in the frame immediately thereafter. Specifically, there are a mode of alternately repeating “random determination” and “reversal”, and a mode of making “random determination” after multiple repetitions of “reversal” after “random determination.” Thus, in the former mode, the voltage supply circuit alternately repeats the random polarity determination and the polarity determination by reversal. On the other hand, in the latter mode, the voltage supply circuit repeats multiple times the polarity determination by reversal performed after the random polarity determination.

According to the present invention, provided is a liquid crystal display device which comprises: a liquid crystal display cell including a plurality of pixels arrayed in m rows×n columns, and a plurality of scanning lines and signal lines respectively for transmitting scanning signals and display signals to each of the pixels; a scanning signal supply circuit for supplying the scanning signals to the plurality of scanning lines; a display signal supply circuit for supplying the display signals of different polarities to the adjacent signal lines; and a control unit for supplying a polarity instruction signal to the display signal supply circuit based on random numbers for a pixel positioned in a predetermined column in each pixel row.

In the liquid crystal display device of the present invention, since the scanning signals with a different polarity are supplied to the adjacent signal lines, voltages of +polarity and −polarity are alternately applied to the pixels constituting the same row. On the other hand, since the polarity instruction signal based on random numbers is supplied to the pixel positioned in the predetermined column in each pixel row, to the display signal supply circuit, polarities of voltages to be applied are randomly arranged for a group of pixels constituting the same column. Thus, even when the foregoing particular pattern image is displayed, +polarity and −polarity are present in a mixed manner in each frame, and the occurrence of flickers can be reduced for various image display patterns.

In the liquid crystal display device of the present invention described above, preferably the scanning signal supply circuit supplies each of the pixels in a frame immediately after the preceding frame whose polarity has been determined by the polarity instruction signal based on the random numbers with polarity reverse to that of the preceding frame. By guaranteeing AC drive in units of frame, it is possible to reduce a property deterioration of the liquid crystal material.

As described above, the liquid crystal display device of the present invention is capable of reducing the occurrence of flickers. However, as described in a preferred embodiment section of the present invention, the liquid crystal display device having the reduced occurrence of flickers is not suitable for a drive voltage adjustment operation in a manufacturing process thereof. Thus, a conventional dot reversal drive mode should preferably be provided to facilitate the recognition of flickers in the adjustment operation. That is, the liquid crystal display device of the present invention can further comprises the dot reversal drive mode for realizing a first frame in which adjacent pixels have a different polarity from each other, and a second frame in which polarity of each pixel thereof being different from that of the first frame, the second frame being subsequent to the first frame.

Further, according to the present invention, provided is a liquid crystal display device of an active matrix type having an element for applying a drive voltage to a liquid crystal material which comprises: a liquid crystal display cell including a plurality of pixels arranged in a dot matrix form and the liquid crystal material sealed therein; a control unit for transmitting generated random numbers; and a polarity instruction unit for applying a polarity corresponding to each of the random numbers received from the control unit to a predetermined pixel, and for instructing + and −polarities of other pixels present in the same row to be alternately arrayed by using the polarity of the predetermined pixel as a reference.

The liquid crystal display device of the present invention is capable of, by using random numbers, randomly determining a polarity array in units of row. Moreover, by using the predetermined pixel to which a voltage of a polarity corresponding to the random numbers being applied thereto as a reference, + and −polarities of other pixels present in the same row can be alternately arranged. Thus, even in the case of displaying a checker pattern, since +polarity and −polarities can be mixed in each frame, the occurrence of flickers can be reduced.

In the liquid crystal display device of the present invention, if the plurality of pixels are arrayed in m rows×n columns (m and n are positive integers), the control unit sequentially transmits m random numbers for each predetermined frame, and the polarity instruction unit can determine the polarity of the predetermined pixel by allocating the m random numbers to each row. In this case, the polarity instruction unit determines the polarity of the predetermined pixel, and then determines polarities of other pixels in the row in which the predetermined pixel exists, by using the polarity of the predetermined pixel as a reference. The number of pixels present is m×n, but only m random numbers are required.

According to the present invention, provided is a liquid crystal display device which comprises: a liquid crystal display cell including a plurality of pixels arrayed in m rows×n columns (m and n are positive integers), the plurality of pixels including a reference pixel for determining a polarity array of display signals in each pixel row, and a plurality of scanning lines and signal lines respectively for transmitting scanning signals and display signals to each pixel; a scanning signal supply circuit for supplying the scanning signals to the scanning lines; and a display signal supply circuit for supplying the display signals to the signal lines. In this case, the display signal supply circuit determines a polarity of the display signal to be supplied to the reference pixel of each pixel row based on random numbers in a predetermined frame, and determines a polarity in a frame subsequent to the predetermined frame by reversing the polarity of the predetermined frame.

According to the liquid crystal display device of the present invention, the polarity of the display signal supplied to the reference pixel of each pixel row is determined based on random numbers for the predetermined frame. Thus, unbalance of polarity of a drive voltage, in which either +polarity or −polarity is predominant, in the frame is prevented, even in the case of displaying the checker pattern described above. Therefore, the liquid crystal display device of the present invention is advantageous for reducing the occurrence of flickers. Moreover, since the polarity of the predetermined frame is reversed in the frame subsequent to the predetermined frame, AC drive is guaranteed; therefore, the liquid crystal display device of the present invention is advantageous for preventing the burning of the liquid crystal material.

In the liquid crystal display device of the present invention, the display signal supply circuit can determine polarities of other pixels in a row having said reference pixel therein in such a manner that polarities of the pixels are regularly arrayed. A typical example of the regular arraying is that +polarity and −polarity are alternately arrayed. In other words, the display signal supply circuit can determine the polarities of the other pixels such that each of the pixels in the same row has reversed polarity to that of an adjacent pixel. However, the present invention is not limited to this example. For example, a regular arrangement such as +polarity, +polarity, −polarity, −polarity, and so on, can be employed.

As it can be understood from the foregoing description, according to the present invention, a liquid crystal display device having a novel polarity array of drive voltages therein is provided. Specifically, provided is a novel liquid crystal display device which comprises: a liquid crystal display cell having a plurality of pixels arrayed in a dot matrix form; a display signal supply circuit for supplying display signals to the plurality of pixels in such a way that polarity of the pixels constituting each row are regularly arrayed, and also the polarity of pixels constituting each column are irregularly arrayed; and a scanning signal supply circuit for supplying scanning signals to the plurality of pixels.

Also in the liquid crystal display device of the present invention, to prevent the property deterioration of the liquid crystal material, preferably, the display signal supply circuit supplies the display signals based on the random numbers in a predetermined frame, and supplies the display signals whose polarities are reversed to those of the predetermined frame, in a frame immediately after the predetermined frame.

The present invention is established also as a driving method of a liquid crystal display device. Specifically, a driving method of a liquid crystal display device of the present invention is provided in which a polarity of a voltage applied to each pixel for each frame is reversed. The method comprises the steps of: applying the voltage of a polarity based on random numbers to a preceding first frame; and applying a voltage of a polarity reverse to that of the first frame to a second frame immediately after the first frame.

In addition, if the liquid crystal display device is a liquid crystal display device of an active matrix type provided with elements for applying drive voltages to a liquid crystal material, in the first frame, polarities of voltages applied to the pixels are desirably randomly arrayed in a scanning direction, and polarities of voltages applied to the pixels are desirably regularly arrayed in a direction orthogonal to the scanning direction.

### BRIEF DESCRIPTION OF THE DRAWINGS

For a more complete understanding of the present invention and the advantages thereof, reference is now made to the following description taken in conjunction with the accompanying drawings.

FIG. 1 is a view showing a basic configuration of a liquid crystal display device according to an embodiment of the present invention.

FIG. 2 is a view for illustrating a reversal of polarity by POL signals according to the embodiment.

FIG. 3 is a view showing an example of a display screen, to which the reversal of polarity of the embodiment is applied.

FIG. 4 is a view showing another example of a display screen, to which the reversal of polarity of the embodiment is applied.

FIG. 5(a) and FIG. 5(b) are views showing a specific example of the reversal of polarity of the embodiment.

FIG. 6 is a block diagram showing an example of a specific constitution of a random number generator.

FIG. 7 is a view for illustrating a reversal of polarity by POL signals in a conventional dot reversal drive control system.

FIG. 8 is a view for illustrating the conventional dot reversal drive control system.

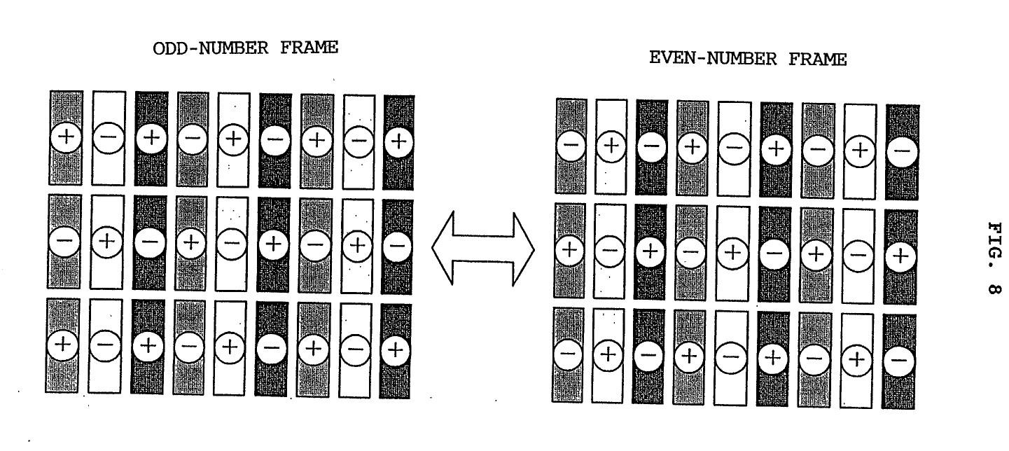

FIG. 9 is a view showing an example of a display screen displayed by the conventional dot reversal drive control system.

FIG. 10 is a view for illustrating an improved conventional dot reversal drive control system.

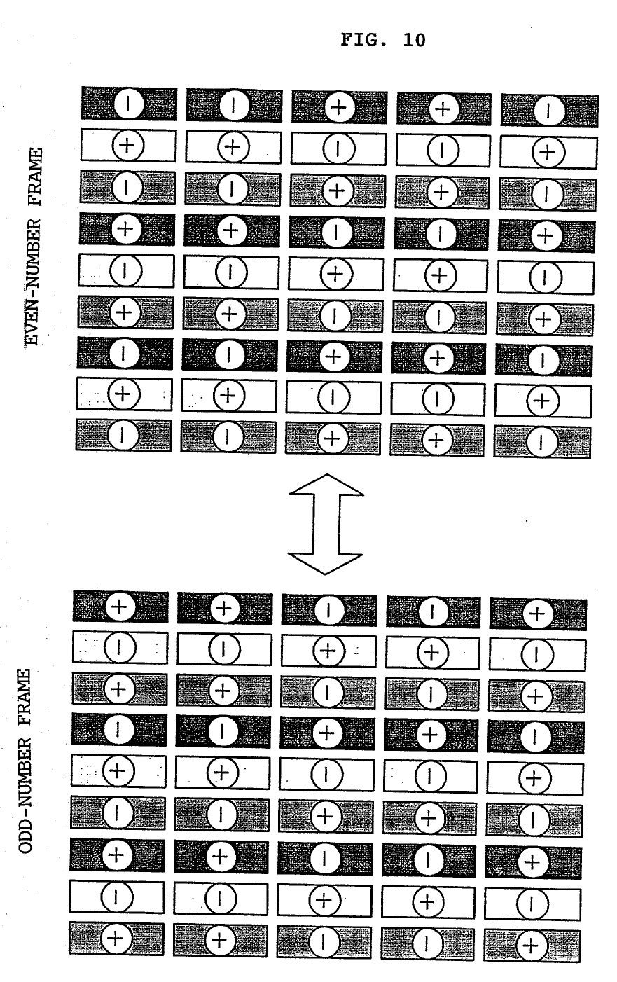

FIG. 11 is a view showing an example of a display screen displayed by the improved conventional dot reversal drive control system.

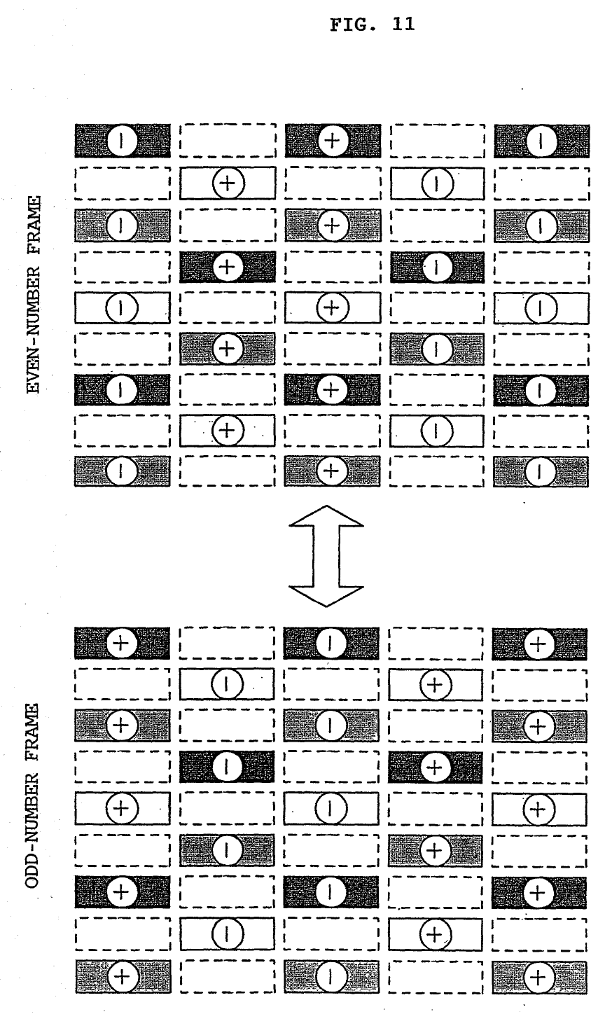

FIG. 12 is a view showing another example of the display screen displayed by the improved conventional dot reversal drive control system.

### DETAILED DESCRIPTION OF THE INVENTION

Next, a preferred embodiment of the present invention will be described with reference to the accompanying drawings.

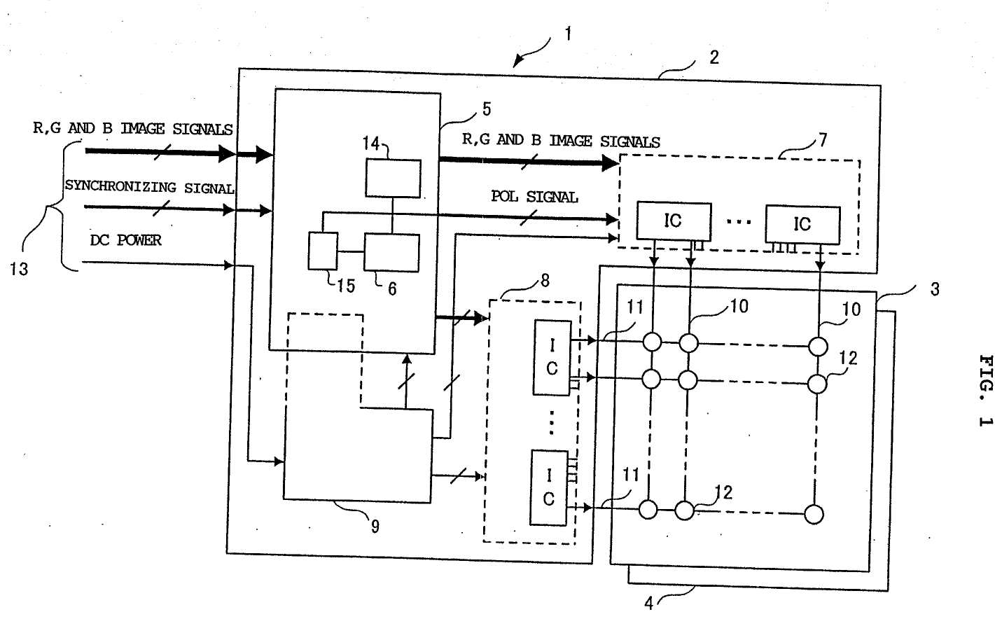

FIG. 1 illustrates a basic configuration of a liquid crystal display device 1 according to the embodiment.

The liquid crystal display device 1 is one of an active matrix type. As generally known, the liquid crystal display device of the active matrix type controls drive of a liquid crystal material by using an active element such as a thin film transistor (TFT) or the like.

The liquid crystal display device 1 comprises a liquid crystal cell control circuit 2, a liquid crystal cell 3, and a backlight unit 4.

The liquid crystal cell control circuit 2 receives R, G and B image data signals and a signal for synchronization from an external system, and outputs to the liquid crystal cell 3 display data and a control signal for driving R, G and B pixels 12 necessary for driving the liquid crystal cell 3. The liquid crystal cell control circuit 2 includes an LCD controller 5, a display signal supply circuit 7, a scanning signal supply circuit 8, and a DC-DC converter 9. The LCD controller 5 receives, for example, digital R, G, and B image data signals and a signal for synchronization via a video interface 13, outputted from a graphics controller LSI of a computer system (not shown). In the liquid crystal display device 1 of the embodiment, a power source to the liquid crystal cell control circuit 2 is also supplied via the video interface 13. The LCD controller 5 processes the signals received from the video interface 13, and outputs the processed signals to IC constituting the display signal supply circuit 7 and IC constituting the scanning signal supply circuit 8. The signals supplied to the IC constituting the display signal supply circuit 7 include the R, G, and B image data signals and a polarity instruction signal (referred to as POL signal in the drawings). Accordingly, the display signal supply circuit 7 also functions as a polarity instruction unit. The signals supplied to the IC of the scanning signal supply circuit 8 include a control signal.

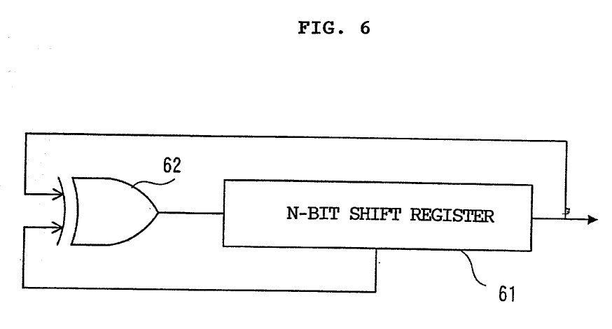

The LCD controller 5 includes a random number generator 6. A specific example of the random number generator 6 is shown in FIG. 6. As shown in FIG. 6, for the random number generator 6, a known random number generator can be used, which is composed of an N-bit shift register 61 and an inclusive OR circuit 62 for feedback. This random number generator 6 continuously generates random numbers corresponding to the number of rows on the liquid crystal cell 3 for each predetermined frame. For example, assuming that m rows of pixels 12 constituting a dot matrix are present, the random number generator 6 continuously generates m random numbers for each predetermined frame. The N-bit shift register 61 can generate pseudo random numbers at a cycle corresponding to N. In this random number generator 6, the N-bit shift register 61 may be reset for each predetermined frame or for every predetermined time, thereby changing the repetitive cycle of pseudo random numbers.

The LCD controller 5 also includes a memory 15 for storing the random numbers (columns) generated by the random number generator 6. By using the random numbers (columns) stored in the memory 15, a POL signal of an opposite polarity is generated. The LCD controller 5 also includes a dot reversal drive control circuit 14 for performing a conventional dot reversal drive control. Reason for the inclusion of the dot reversal drive circuit 14 will be described later.

The display signal supply circuit 7 supplies a display signal via signal lines 10 to each of the pixels 12 arrayed on the liquid crystal cell 3 in a matrix form. In this case, the display signal supply circuit 7 determines a voltage polarity of the display signal to be supplied based on the POL signal supplied from the LCD controller 5. For example, assuming that there are m rows of pixels 12 constituting the dot matrix and the POL signals consisting of m random numbers are received, the POL signals are allocated each of the rows. According to the embodiment, the display signal supply circuit 7 is adapted to output the display signal from output pins constituting the IC in such a way that a polarity of the data signal outputted from adjacent outputs pin can be reversed.

The scanning signal supply circuit 8 supplies a scanning signal via scanning lines 11 to each of the pixels 12 arrayed on the liquid crystal cell 3 in the matrix form.

The DC-DC converter 9 as a power source circuit unit supplies power source voltages necessary in the LCD controller 5, the display signal supply circuit 7, and the scanning signal supply circuit 8, based on a DC power source voltage supplied via the video interface 13.

The liquid crystal cell 3 has a basic structure, where a liquid crystal material is sealed in between a glass substrate referred to as an array substrate having TFTs arrayed thereon and a color filter substrate having a color filter formed thereon. The liquid crystal cell 3 includes pixels 12 formed on each of intersections of a plurality of signal lines 10 and a plurality of scanning lines 11 arrayed in the matrix form on the array substrate. Each of the pixels 12 has a TFT as an active element disposed therein. Each TFT is a 3-terminal switching element provided with a gate electrode connected to each of the scanning lines 11, a source electrode connected to each of the signal lines 10, a drain electrode, and a pixel electrode. Each TFT is subjected to ON/OFF control upon receiving the scanning signal from the scanning signal supply circuit 8 at the gate electrode. A data signal supplied from the display signal supply circuit 7 is applied through the source and drain electrodes to the pixel electrode, and then image displaying is executed.

The backlight unit 4 generally includes a fluorescent tube as a light source, an inverter circuit for lighting the fluorescent tube, and a member as a light transmission path.

The liquid crystal display device 1 of the embodiment is characterized in that the POL signals are supplied based on the random numbers generated by the random number generator 6. Before explaining the reversal of polarity of the present invention, reversal of polarity performed in the conventional dot reversal drive control system will be described based on its relation to the POL signal.

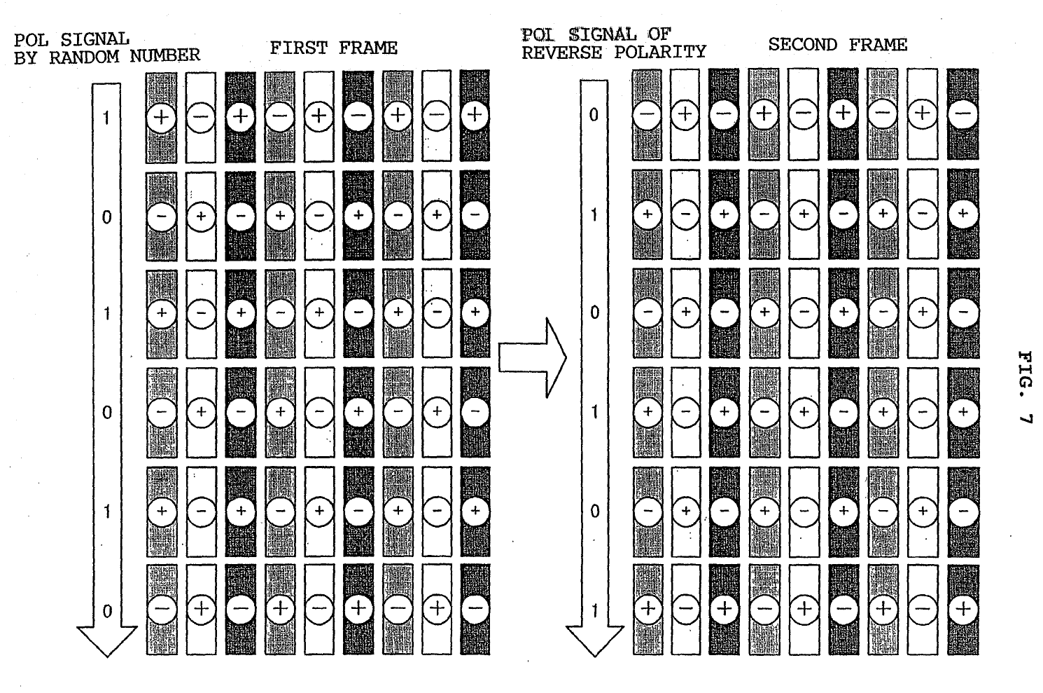

FIG. 7 illustrates reversal of polarity based on POL signals, performed in the conventional dot reversal drive control system. In FIG. 7, as described above, in the dot reversal drive control system, regarding writing polarities into pixels, a pixel of +polarity in an odd-number frame exhibits −polarity in an even-number frame, while a pixel of −polarity in the odd-number frame exhibits +polarity in the even-number frame. In addition, in any frames, writing voltages are in phase for pixels adjacent to each other in a diagonal direction. Polarity of each pixel in one row is defined by the POL signal. In the example of FIG. 7, two kinds of POL signal are present, i.e., 0 (zero) and 1. As shown in FIG. 7, basically, polarities of pixels in the same row are arranged by alternately arraying +polarity and −polarity. In FIG. 7, the POL signal is shown in a corresponding relation to each row. That is, when the POL signal is 0, polarity of a pixel positioned in a left end in the same row is defined as −. It can also be understood that the POL signals 0 and 1 are alternately arrayed.

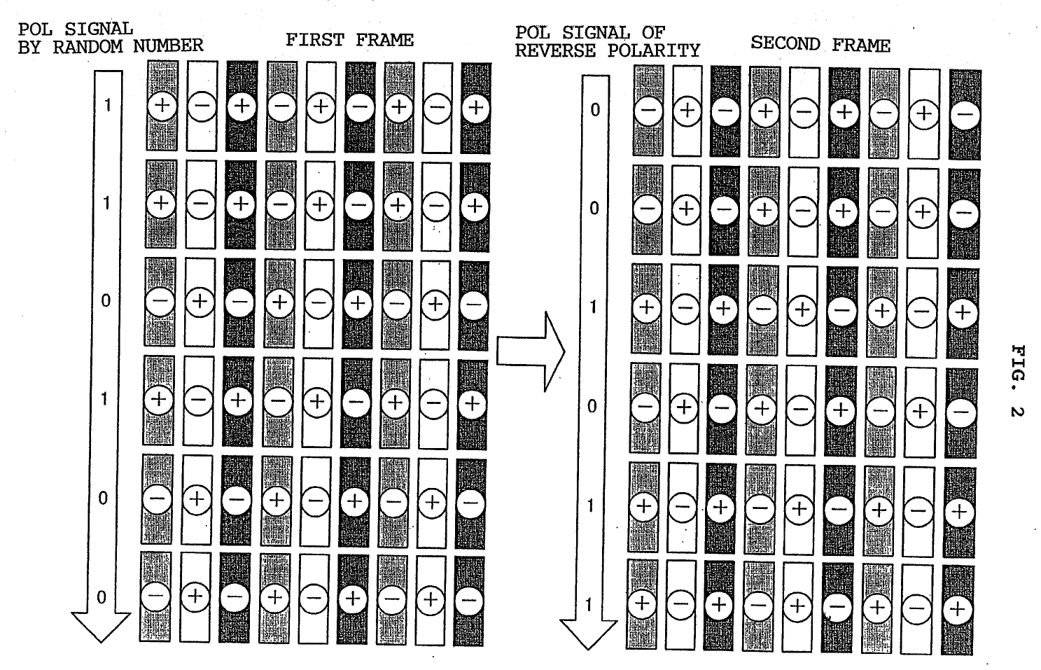

On the other hand, according to the embodiment, the POL signals for an odd-number frame are generated based on random numbers generated by the random number generator 6. Now, polarity reversal drive control system using POL signals defined based on such random numbers will be described by referring to FIG. 2.

In a first (odd-number) frame, the POL signal for the pixel of a 1st row and a 1st column is “1”; the POL signal for the pixel of a 2nd row and the 1st column “1”; the POL signal for the pixel of a 3rd row and the 1st column “0”; the POL signal for the pixel of a 4th row and the 1st column “1”; the POL signal for the pixel of a 5th row and the 1st column “0”; and the POL signal for the pixel of a 6th row and the 1st column “0.”The POL signals of “0” and “1” are based on the random numbers generated by the random number generator 6. Here, the pixel of the 1st column of each row becomes a reference for polarity to be applied to other pixels belonging to the row. In other words, the pixel of a 2nd column takes a polarity reverse to that of the pixel of the 1st column, the pixel of a 3rd column takes a polarity reverse to that of the pixel of the 2nd column, and so on. This is because the display signal supply circuit 7 having a polarity instruction function applies voltages of opposite polarity to each other to the adjacent signal lines 10. In the embodiment, the pixel disposed in the 1st column is set as a reference pixel for polarity determination. However, a pixel disposed in any of the other predetermined positions may serve as a reference pixel. Moreover, it can be understood that in the first frame, the display signal supply circuit 7 supplies display signals in such a way that polarities of pixels constituting each row are regularly arrayed, and polarities of pixels constituting each column are irregularly arrayed.

In a second (even-number) frame, a POL signal is applied in such a manner that polarity of each of the pixels is opposite to that of each of the pixels in the first (odd-number) frame. That is, the POL signal for the pixel of a 1st row and a 1st column is “0”; the POL signal for the pixel of a 2nd row and the 1st column “0”; the POL signal for the pixel of a 3rd row and the 1st column “1”; the POL signal for the pixel of a 4th row and the 1st column “0”; the POL signal for the pixel of a 5th row and the 1st column “1”; and the POL signal for the pixel of a 6th row and the 1st column “1.”

FIG. 2 shows the examples of only the first frame as an odd-number frame, and the second frame as an even-number frame. Thereafter, however, the reversal of polarity is repeated, i.e., polarity based on random numbers generated by the after-mentioned random number generator 6, opposite polarity and so forth.

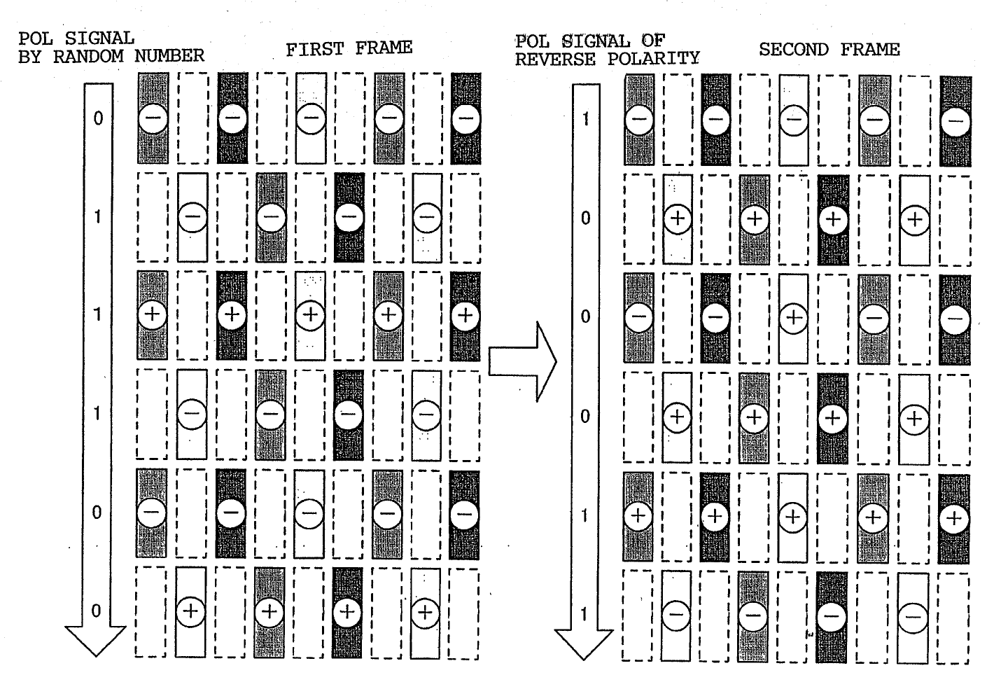

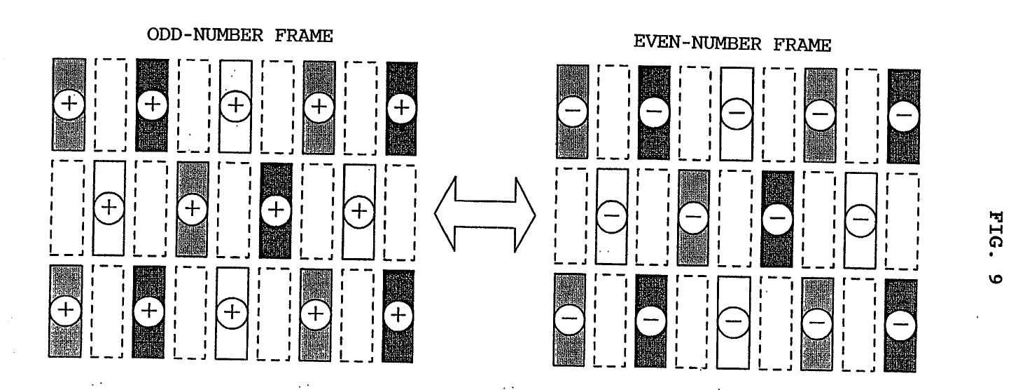

FIG. 3 schematically shows the state in which a checker pattern in units of pixel shown in FIG. 9 is displayed by using the drive control system of the embodiment.

In the example of FIG. 3, the POL signals in a first frame as an odd-number frame are generated by the random number generator 6. Specifically, the POL signal for the pixel of a 1st row and a 1st column is “0”; the POL signal for the pixel of a 2nd row and the 1st column “1”; the POL signal for the pixel of a 3rd row and the 1st column “1”; the POL signal for the pixel of a 4th row and the 1st column “1”; the POL signal for the pixel of a 5th row and the 1st column “0”; and the POL signal for the pixel of a 6th row and the 1st column “0.” In addition, in a second frame as an even-number frame, the POL signal is supplied in such a way that polarity of each pixel is opposite to that of each pixel in the first frame. Specifically, the POL signal for the pixel of a 1st row and a 1st column is “1”; the POL signal for the pixel of a 2nd row and the 1st column “0”; the POL signal for the pixel of a 3rd row and the 1st column “0”; the POL signal for the pixel of a 4th row and the 1st column “0”; the POL signal for the pixel of a 5th row and the 1st column “1”; and the POL signal for the pixel of a 6th row and the 1st column “1.”

As shown in FIG. 3, according to the embodiment, even in the case where a displayed image is a checker pattern in units of pixel, the pixels of +polarity and −polarity are present in a mixed manner both in the first and second frames. Thus, unlike the case of the conventional dot reversal drive control system, no difference occurs in brightness between each of the frames.

Similarly to FIG. 2, FIG. 3 shows only the two frames, i.e., the first and second frames. Thereafter, however, for a third frame, a fourth frame, and so on, the reversal drive control is repeated alternately between polarity based on random numbers and opposite polarity.

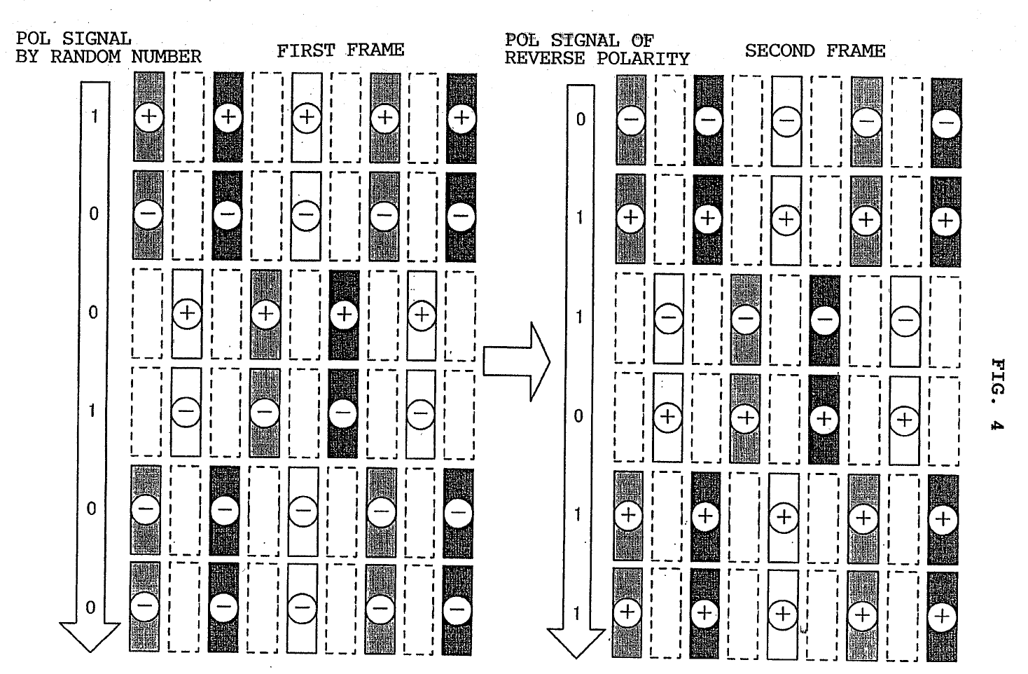

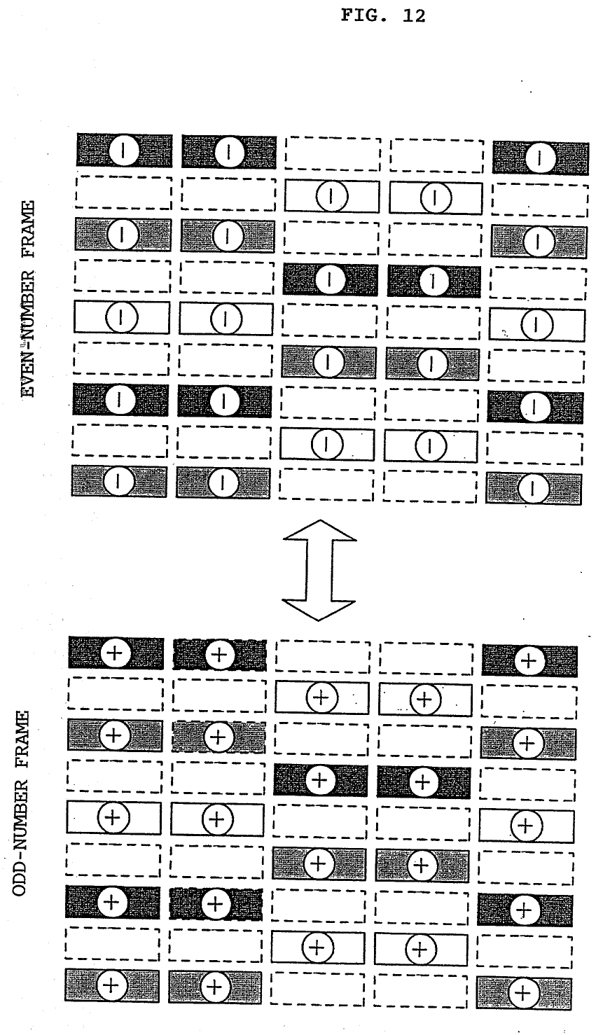

FIG. 4 schematically shows the state in which a checker pattern in unit of 1 row×2 columns shown in FIG. 12 is displayed by using the drive control system of the embodiment.

In the example of FIG. 4, the POL signals in a first frame as an odd-number frame are generated by the random number generator 6. Specifically, the POL signal for the pixel of a 1st row and a 1st column is “1”; the POL signal for the pixel of a 2nd row and the 1st column “0”; the POL signal for the pixel of a 3rd row and the 1st column “0”; the POL signal for the pixel of a 4th row and the 1st column “1”; the POL signal for the pixel of a 5th row and the 1st column “0”; and the POL signal for the pixel of a 6th row and the 1st column “0.” In addition, in a second frame as an even-number frame, the POL signal is supplied in such a way that polarity of each pixel is opposite to that of each pixel in the first frame. Specifically, the POL signal for the pixel of a 1st row and a 1st column is “0”; the POL signal for the pixel of a 2nd row and the 1st column “1”; the POL signal for the pixel of a 3rd row and the 1st column “1”; the POL signal for the pixel of a 4th row and the 1st column “0”; the POL signal for the pixel of a 5th row and the 1st column “1”; and the POL signal for the pixel of a 6th row and the 1st column “1.”

As shown in FIG. 4, according to the embodiment, even in the case where a displayed image is a checker pattern in unit of 1 row×2 columns, the pixels of +polarity and −polarity are present in a mixed manner both in the first and second frames. Thus, compared with the conventional dot reversal drive control system, it is possible to reduce a difference in brightness between each of the frames.

Similarly to FIG. 2, FIG. 4 shows only the two frames, i.e., the first and second frames. Needless to say, however, the reversal drive control repeated between polarity based on random numbers and opposite polarity is executed for a third frame, a fourth frame, and so on, thereafter.

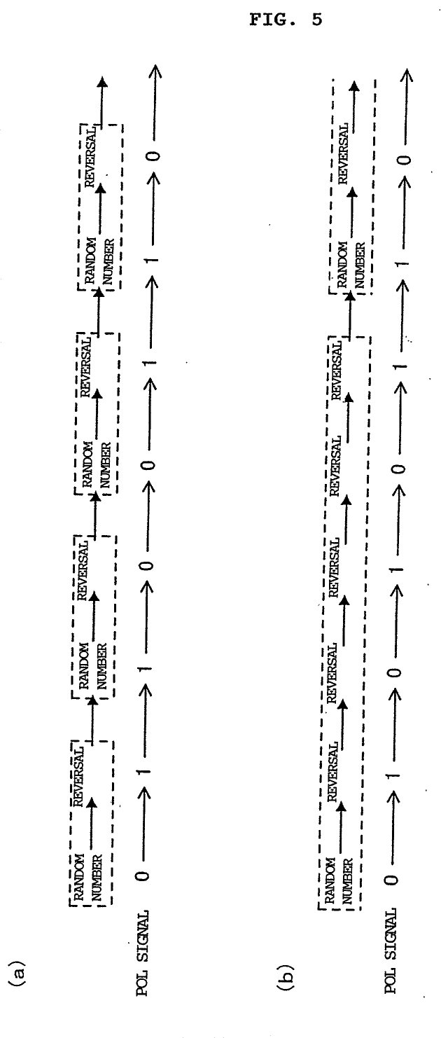

The polarity reversal drive control method of the embodiment shown in FIGS. 2 to 4 is based on the assumption that a set of determining the polarity of each pixel in units of row based on random numbers and reversing the polarity is repeated. FIG. 5(a) shows a contrast between the POL signals. In FIG. 5(a), the POL signals only for a particular pixel (row) is shown. In addition, in FIG. 5(a), “random number” means that a polarity is determined based on random numbers generated by the random number generator 6, and “reversal” means that the polarity of each pixel is reverse to that of the frame immediately before. Specifically, in the case of FIG. 5(a), the polarity reversal drive control system is established, where “random number” and “reversal” are repeated alternately. Also in this reversal drive control system, random numbers are generated by the random number generator 6 for every two frames, and polarities of the frames are determined based on the generated random numbers. However, as shown in FIG. 5(a), if random numbers generated for every two frames are “0”, “1”, “0” and “1” in order, the POL signals form a pattern of “0”, “1”, “1”, “0”, “0”, “1”, “1”, and “0.” The reversal of polarity of this pattern is equivalent to ½ of the AC drive frequency. Since a drive frequency of a general liquid crystal display device is 60 Hz, an effective AC drive frequency of the foregoing pattern becomes 30 Hz. In terms of reliability of the liquid crystal material sealed in the liquid crystal cell 3, a drive frequency of 60 Hz is more preferable than 30 Hz.

Thus, according to the reversal drive control system of the embodiment, in addition to the case in FIG. 5(a) in which the set of “random number” and “reversal” is constituted of one “random number” frame and one “random number” frame, a reversal drive control system as shown in FIG. 5(b) is proposed. Note that, the definitions of “random number” and “reversal” of FIG. 5(b) are the same as those of FIG. 5(a).

FIG. 5(b) is an example of one set constituted of six frames. That is, a frame immediately after “random number” is “reversal” as in the case shown in FIG. 5(a). However, in the case of FIG. 5(b), “reversal” is set for all four frames thereafter, and “random number” is set for a frame thereafter, namely a 7th frame. Then, “reversal” is set for all five frames including a frame immediately thereafter. Accordingly, by reducing the frequency of the generation of the random numbers, excessive lowering of effective drive frequency can be prevented as shown in FIG. 5(a). Needless to say, how frequently the random numbers should be generated in terms of frames cannot be determined unequivocally. It is assumed that the repetition of “reversal” may not be preferable for a particular screen pattern. Therefore, for electing the frequency of times of the generation of the random numbers, consideration must be given to a balance between the reliability of the liquid crystal material and image quality.

As described above, according to the embodiment, since the reversal of polarity in units of row is randomly performed by using random numbers, it is possible to reduce flickers when a particular checker pattern is displayed in units of pixel or in unit of 1 row×2 columns.

Incidentally, a manufacturing process of a liquid crystal display device has conventionally included a step called “flicker adjustment.” This step is designed to minimize flickers in the liquid crystal display device visually or by using a special tool. This “flicker adjustment” step has another aspect. That is, in a state where flickers are easily recognized, a direct-current (DC) voltage is applied to the liquid crystal material, and displaying the same screen may cause burning of the liquid crystal material. Thus, the “flicker adjustment” step has the aspect that the application of the DC voltage to the liquid crystal material is prevented by adjusting a drive voltage so as to minimize flickers.

In the liquid crystal display device 1 to which the embodiment is applied, because the recognition of flickers is made difficult, the adjustment of the drive voltage may become difficult in the manufacturing process. Thus, the dot reversal drive control circuit 14 is provided for the liquid crystal display device 1 of the embodiment. In the flicker adjustment step, a checker pattern image is displayed and the drive voltage is adjusted simultaneously while the dot reversal drive control circuit 14 is activated. Then, the reversal drive control system of the embodiment is set, thus allowing the execution of the drive voltage in the conventional manner.

According to the embodiment, as described below, compared with the conventional dot reversal drive control system, a better effect in reduction of power consumption can be expected. In the conventional dot reversal drive control system, the reversal of polarity is always performed by one frame unit. On the other hand, in the present embodiment, since polarities are determined based on random numbers, there may be a case where no reversal of polarity is executed. For example, in FIG. 5(a), when “reversal” shifts to “random number”, the POL signals are “1” for both. This means that voltages of the identical polarity are continuously applied to the pixel, in other words, the frequency of the reversal can be reduced. In this case, in the liquid crystal display device 1, not only writing charges into the pixels 12 reversing outputs from the display signal supply circuit 7 from +polarity to −polarity, or from −polarity to +polarity but also the power consumed for charging/discharging the signal lines 10 cannot be ignored. Therefore, in the liquid crystal display device 1 of the embodiment, in which the number of times of reversal may be reduced, the advantage of reducing power consumption can be expected.

As described above, according to the present invention, it is possible to reduce the occurrence of flickers in a special display image such as a checker pattern in units of pixel or the like.

Although the preferred embodiments of the present invention have been described in detail, it should be understood that various changes, substitutions and alternations can be made therein without departing from spirit and scope of the inventions as defined by the appended claims.

What is claimed is:

1. A display device comprising:
a display cell which includes a display optical element and displays an image by controlling light transmission based on a drive voltage applied to the display optical element; and
a voltage supply circuit which randomly determines a polarity of the drive voltage in a predetermined frame, and which determines a polarity of the drive voltage in a frame subsequent to the predetermined frame by reversing the randomly determined polarity.

2. The display device according to claim 1, wherein said display cell has a plurality of pixels arrayed in a dot matrix form having rows and columns, and said voltage supply circuit performs random polarity determination in units of row constituting the dot matrix.

3. The display device according to claim 2, wherein said voltage supply circuit supplies the drive voltage such that adjacent pixels in the same row are different from each other in polarity.

4. The display device according to claim 1, wherein said voltage supply circuit alternately repeats the random polarity determination and the polarity determination by reversal.

5. The display device according to claim 1, wherein said voltage supply circuit repeats the polarity determination by reversal multiple times after the random polarity determination.

6. A liquid crystal display device comprising:
a liquid crystal display cell having a plurality of pixels arrayed in m rows and n columns, and having a plurality of scanning lines and signal lines respectively for transmitting scanning signals and display signals to each of the pixels;
a scanning signal supply circuit for supplying the scanning signals to the plurality of scanning lines;
a display signal supply circuit for supplying the display signals of different polarity to adjacent signal lines; and
a control unit for supplying a polarity instruction signal to the display signal supply circuit based on a random number for the pixel positioned in a predetermined column in each pixel row.

7. The liquid crystal display device according to claim 6, wherein said scanning signal supply circuit supplies each of the pixels in a first frame with polarity determined by the polarity instruction signal based on the random numbers, and supplies each of the pixels in a second frame with polarity reverse to that of the first frame.

8. The liquid crystal display device according to claim 6, further comprising:
a dot reversal drive mode for realizing a first frame in which adjacent pixels have a different polarity from each other, and a second frame in which the polarity of each pixel thereof is different from that of the first frame, the second frame being subsequent to the first frame.

9. A liquid crystal display device of an active matrix type having an element for applying a drive voltage to a liquid crystal material, the liquid crystal display device comprising:
a liquid crystal display cell having a plurality of pixels arranged in a dot matrix form and the liquid crystal material sealed therein;
a control unit for transmitting generated random numbers; and
a polarity instruction unit for applying a polarity corresponding to each of the random numbers received from said control unit to a predetermined pixel, and for instructing positive and negative polarities of other pixels present in the same row to be alternately arrayed by using the polarity of the predetermined pixel as a reference.

10. The liquid crystal display device according to claim 9, wherein the plurality of pixels are arrayed in m rows and n columns (m and n are positive integers), said control unit sequentially generates m random numbers for each predetermined frame, and said polarity instruction unit determines the polarity of the predetermined pixel by allocating the m random numbers to each row.

11. The liquid crystal display device according to claim 9, wherein said polarity instruction unit determines a polarity of the predetermined pixel, and determines polarities of other pixels in the row in which the predetermined pixel exists by using the polarity of the predetermined pixel as a reference.

12. A liquid crystal display device comprising:
a liquid crystal display cell having a plurality of pixels arrayed in m rows and n columns (m and n are positive integers), the plurality of pixels including a reference pixel for determining a polarity array of display signals in each pixel row, and a plurality of scanning lines and signal lines respectively for transmitting scanning signals and display signals to each pixel;
a scanning signal supply circuit for supplying the scanning signals to said scanning lines; and
a display signal supply circuit for supplying the display signals to the signal lines,
wherein said display signal supply circuit determines a polarity of the display signal to be supplied to the reference pixel of each pixel row based on random number in a predetermined frame, and determines a polarity in a frame subsequent to said predetermined frame by reversing said polarity of the predetermined frame.

13. The liquid crystal display device according to claim 12, wherein said display signal supply circuit determines polarities of other pixels in a row having the reference pixel therein such that polarities of the pixels are regularly arrayed.

14. The liquid crystal display device according to claim 13, wherein said display signal supply circuit determines polarities of other pixels such that each of the pixels in the same row has a polarity reverse to that of adjacent pixels.

15. A liquid crystal display device comprising:
a liquid crystal display cell having a plurality of pixels arrayed in a dot matrix form;
a display signal supply circuit for supplying display signals to the plurality of pixels such that polarities of the pixels constituting each row are regularly arranged, and the polarities of pixels constituting each column are irregularly arranged; and
a scanning signal supply circuit for supplying scanning signals to the plurality of pixels.

16. The liquid crystal display device according to claim 15, wherein said display signal supply circuit supplies the display signal based on random numbers in a predetermined frame, and supplies the display signals whose polarities are reverse to those of said predetermined frame in a frame immediately after said predetermined frame.

17. A driving method of a liquid crystal display device in which a polarity of a voltage applied to each pixel is reversed for each frame, the method comprising the steps of:
applying voltages of polarities based on random numbers for a first frame; and
applying voltages of polarities reverse to those of the first frame for a second frame immediately after the first frame.

18. The driving method for the liquid crystal display device according to claim 17, wherein said liquid crystal display device is a liquid crystal display device of an active matrix type provided with elements for applying drive voltages to a liquid crystal material, and in said first frame, the polarities of voltages applied to pixels are randomly arrayed in a scanning direction, and the polarities of voltages applied to the pixels are regularly arrayed in a direction orthogonal to the scanning direction.
